(19) United States
(12) Patent Application Publication
(10) Pub. No.: US 2011/0077950 A1
(43) Pub. Date: Mar. 31, 2011

(54) Risk profiling system and method

(75) Inventor: Roger Hughston, Lancaster, CA (US)

(73) Assignee: DISNEY ENTERPRISES, INC., BURBANK, CA (US)

(21) Appl. No.: 12/586,891

(22) Filed: Sep. 28, 2009

(51) Int. Cl. G06Q 99/00

(52) U.S. Cl. 705/1.1

(57) ABSTRACT

There is provided a risk profiling system and method. The risk profiling system comprises a system processor, a system memory storing a risk profile unit configured to be controlled by the processor. The risk profile unit includes a risk features database comprising a plurality of risk features corresponding to the adverse event, an aggregation module configured to group risk features detected by the risk profiling system, and a risk analysis engine configured to estimate the likelihood of the adverse event from the grouped risk features.

### BACKGROUND OF THE INVENTION

1. Field of the Invention

The present invention relates generally to risk assessment. More particularly, the present invention relates to estimating the likelihood of an adverse event.

2. Background Art

Risk assessment can make important contributions to a broad spectrum of endeavors otherwise having little in common. For example, the private insurance industry and the public corrections system may both benefit from risk profiling. With respect to insurance, accurate modeling of risk is essential to the profitability of companies who generate their revenues from the promise of hazard indemnification. At the same time, scarce public resources and even public safety itself may be at stake when corrections departments use risk profiles in formulating sentencing and/or parole recommendations. Large private venues such as theme parks or destination resorts, and virtual environments capable of supporting large visitor populations may use risk profiling as well, for example, to evaluate the potential for adverse or otherwise undesirable interactions between visitors to the physical venue or virtual space.

Heavily populated environments in particular, be they virtual or real, can place substantial burdens on the resources available to provide security or intervention should an adverse event, such as a conflict, act of physical or sexual abuse, or harassment, for example, occur among the visitors to a venue. As a result, risk profiling may be used in an attempt to identify and preempt those adverse events at their inception, or earlier. One conventional approach to identifying adverse events in the form of potentially undesirable social interactions in a large venue includes monitoring the conduct and/or language used by visitors, to detect specific behaviors or expressions.

For example, an attempt to prevent undesirable interactions among visitors to a chat room or online community may be performed by monitoring the communications among visitors for the presence of key words or phrases identified as indicative of the conduct to be suppressed. In that instance, profanity, overtly sexual expressions, derogatory or threatening words, and the like, may be identified as trigger expressions symptomatic of an incipient adverse event. However, because even friendly interactions may include one or more trigger expressions, the conventional approach typically increments a count of trigger expressions by each such expression detected in an interaction, and then acts affirmatively to intervene only when a particular count total is achieved.

While perhaps effective in providing a crude level of risk assessment, the conventional approach described above is both inefficient and less than optimally effective in identifying potentially adverse events. The conventional approach is inefficient because, by calling for intervention on the basis of a mere aggregate count of trigger expressions, precious security resources may be over utilized or misdirected for little or no reason, due to “false alarms.” For instance, a single individual who, without malice, repeatedly utters a profanity may trigger an unnecessary intervention.

The same conventional approach may be ineffective if the security assets temporarily dedicated to the previously described profane and verbally incontinent utterer are unavailable or delayed when another, more serious, adverse event is detected. Both the inefficiency and the relative ineffectiveness of the conventional approach are simply magnified as the number of venue visitors and the real or virtual size of the venue grows.

Accordingly, there is a need to overcome the drawbacks and deficiencies in the art by providing a risk profiling solution capable of estimating the likelihood of an adverse event so as to enable effective intervention when appropriate, while also reducing unnecessary resource expenditures due to false alarms.

### SUMMARY OF THE INVENTION

There are provided risk profiling systems and methods, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an example risk profiling system, according to one embodiment of the present invention; and

FIG. 2 is a flowchart presenting a method for use by a processor of a risk profiling system for evaluating the likelihood of an adverse event, according to one embodiment of the present invention.

### DETAILED DESCRIPTION OF THE INVENTION

The present application is directed to a risk profiling system and a method for use by that system for evaluating the likelihood of an adverse event. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

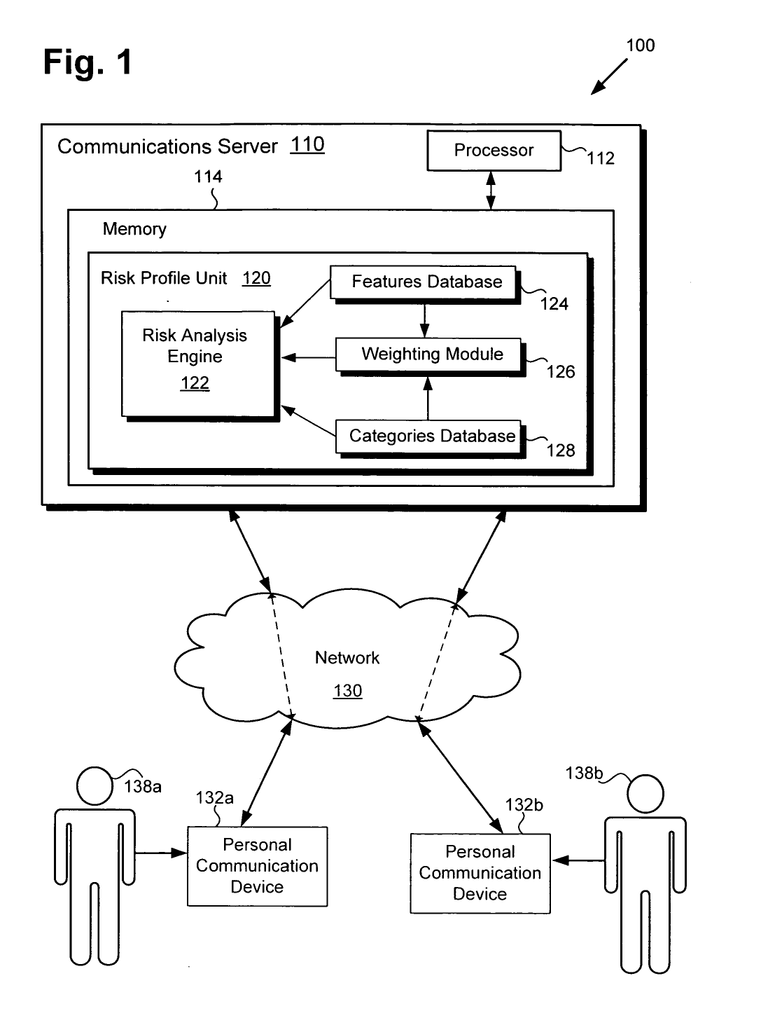

FIG. 1 shows a diagram of example risk profiling system 100, according to one embodiment of the present invention. In the embodiment of FIG. 1, risk profiling system 100 comprises communications server 110 including processor 112 and memory 114. As shown in FIG. 1, example risk profiling system 100 also includes risk profile unit 120 including risk analysis engine 122, risk features database 124, weighting module 126, and adverse event categories database 128. Also shown in FIG. 1 are communication network 130, personal communication devices 132a and 132b, and users 138a and 138b.

Users 138a and 138b may be users utilizing communications server 110 to send messages to other users of a virtual community, or they may be recipient users receiving messages mediated by communications server 110, for example. In one embodiment, for instance, network 130 may comprise a packet network such as the Internet, and users 138a and 138b may be remotely located from one another, but interact through mutual participation in a chat room hosted on communications server 110. In another embodiment, network 130 may be a local network facilitating communication across a physical venue, such as a theme park or destination resort. In that embodiment, users 138a and 138b may be theme park visitors or resort guests physically located within that respective venue and communicating with one another through communications server 110.

According to the embodiment of FIG. 1, users 138a and 138b may utilize respective personal communication devices 132a and 132b, which may be computers, personal digital assistants (PDAs), or mobile telephones, for example. Because, as shown in FIG. 1, communications among users 138a and 138b are mediated by communications server 110, risk profiling system 100 can employ risk profile unit 120 to estimate the likelihood of an adverse event, such as an undesirable human interaction between users 138a and 138b, for instance. Thus, the adverse events evaluated by risk profiling system 100 may include physical or linguistic confrontations between users 138a and 138b, or an inappropriate real or virtual sexual interaction between users 138a and 138b, for example. Alternatively, or in combination with evaluation of adverse events comprising undesirable human interactions, risk profiling system 100 may also be implemented to evaluate adverse events including emergency situations, such as fire or injury, natural disasters, environmental anomalies, and the like.

Processor 112 of risk profiling system 100 may be configured to utilize risk profile unit 120 to evaluate the likelihood of an adverse event as described above. In one embodiment, risk profile unit 120 may include risk analysis engine 122, risk features database 124, and weighting module 126, with adverse event categories database 128 being omitted from that embodiment. Risk features database 124 may comprise a plurality of risk features, such as linguistic expressions identified as trigger expressions precipitating or otherwise corresponding to adverse events. For example, a plurality of risk features comprising individual words, word combinations, and/or phrases, such as insults, slurs, salacious comments, or the like, may be utilized as a reference database by risk analysis engine 122 in estimating the likelihood of an adverse event.

Weighting module 124 may be configured to assign a weighting factor to the risk features extracted by risk profiling system 100. It is noted that a single risk feature may correspond to more than one potential adverse event. Because the predictive relevance of such a risk feature may vary considerable among different adverse events, weighting module 126 can enable risk analysis engine 122 to render a more accurate determination of probability of occurrence of a particular adverse event from the weighted risk features, than if non-weighted risk features were used, as typically occurs in the conventional approach to risk assessment described previously. As a result, not only can risk profiling system 100 be configured to alert an administrator of the system if the probability of occurrence of an adverse event reaches a predetermined threshold, but that alert can be issued with a reduced risk of producing a false alarm compared to risk assessment systems utilizing the conventional approach.

Although the embodiment of FIG. 1 characterizes risk profile unit 120 as including weighting module 126, more generally, weighting module 126 may be interpreted as a proxy for an aggregation module. In the more general case, an aggregation module is configured to group the risk features extracted by risk profiling system 100. Grouping of the extracted risk features may be performed according to the analytic technique applied by risk analysis engine 122. For example, in embodiments in which risk analysis engine is configured to perform a linear or logistic regression on grouped risk features, the aggregation module may comprise weighting module 126, as shown in FIG. 1. However, in embodiments in which risk analysis engine 122 is configured to perform nearest neighbor or Bayesian analysis, for example, grouping of the risk features by the aggregation module may not including a weighting operation.

Returning to the embodiment of risk profiling system 100, as shown in FIG. 1, in that embodiment risk profile unit 120 may further comprise adverse event categories database 128. In such embodiments, weighting module 126 may be configured to assign weighting factors to the risk features detected by risk profiling system 100 according to the adverse event category corresponding to each extracted risk feature. As previously mentioned, in some embodiments, weighting module 126 may assign weighting factors to identified risk features according to the specific individual adverse events to which the risk features correspond. However, under some circumstances, a particular risk feature may have substantially the same predictive relevance for all adverse events identified with a certain category of adverse events. For example, the word “flame” may have substantially the same high predictive relevance to all adverse events identified as corresponding to the adverse event category “fire.” Consequently, inclusion of adverse event categories database 128 in risk profile unit 120 may result in a reduction in the number of iterative steps required of risk analysis engine 122 in estimating the likelihood of occurrence of an adverse event, thus streamlining what may be a complex determinative process.

Moreover, in some embodiments in which risk profile unit 120 includes adverse event categories database 128, risk analysis engine 122 can be further configured to prioritize the estimation of the likelihood of an adverse event according to its category. For instance, risk analysis engine 122 may utilize adverse event categories database 128 to estimate the likelihood of adverse events related to the category “fire” before estimating the likelihood of adverse events related to the category “offensive vulgar or profane language.”

Although the embodiment of FIG. 1 shows risk profile unit 120 residing on communications server 110, that need not be the case for all embodiments. For example, in some embodiments, risk profile unit 120 may reside on a system memory of risk profiling system 100 that is located remotely from communications server 110, but accessible to processor 112 through network 130. In those embodiments, risk profile unit 120 may comprise a web based software applications module, accessible over a packet network such as the Internet, for example. Alternatively, risk profile unit 120 may be located on system memory residing within a local area network (LAN), for instance, or included in another type of limited distribution network. In another embodiment, risk profile unit 120 may reside on a portable computer-readable storage medium such as a compact disc read-only memory (CD-ROM), or universal serial bus (USB) thumb drive, for example.

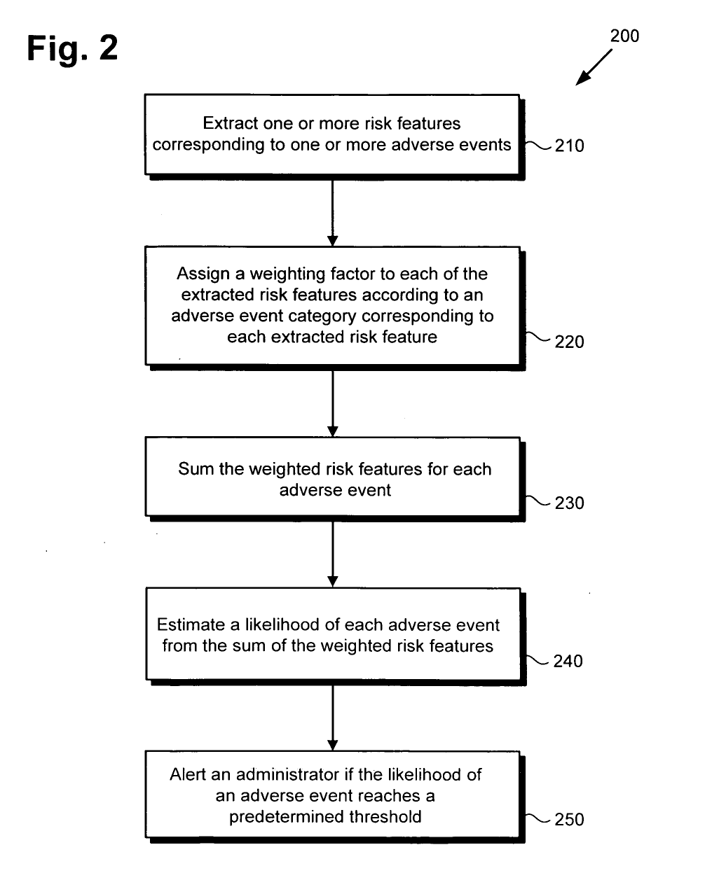

The operation of risk profiling system 100, in FIG. 1, will be further described with reference to FIG. 2. FIG. 2 shows flowchart 200 describing the steps, according to one embodiment of the present invention, of a method for use by a risk profiling system, such as risk profiling system 100, for predicting an adverse event. Certain details and features have been left out of flowchart 200 that are apparent to a person of ordinary skill in the art. For example, a step may comprise one or more substeps or may involve specialized equipment or materials, as known in the art. While steps 210 through 250 indicated in flowchart 200 are sufficient to describe one embodiment of the present invention, other embodiments of the invention may utilize steps different from those shown in flowchart 200, or may include more, or fewer steps.

Referring to step 210 of flowchart 200 and risk profiling system 100 in FIG. 1, step 210 of flowchart 200 comprises extracting one or more risk features corresponding to an adverse event. Step 210 may be performed by risk profile unit 120 in combination with communications server 110, for example, through monitoring of the contents of messages exchanged between user 138a and 138b by reference to risk features database 124. Alternatively, or in addition, step 210 may correspond to extraction of risk features identified in risk features database corresponding to data received from one or more sensors or detectors (not shown in FIG. 1) such as smoke or fire detectors and/or environmental sensors, for example.

The exemplary method of flowchart 200 continues with step 220, which comprises assigning a weighting factor to each of the risk features detected in step 210, to produce one or more weighted risk features. Step 220 may be performed by weighting module 126 of risk profile unit 120, as previously explained in conjunction with FIG. 1. Furthermore, in embodiments in which risk profile unit 120 includes adverse event categories database 128, step 220 may be performed by weighting module 126 according to the adverse event category corresponding to the detected risk feature.

According to the embodiment of FIG. 2, the example method shown by flowchart 200 continues with step 230, comprising summing the weighted risk features produced by step 220 for each adverse event. More generally, a method for use by a risk profiling system for predicting an adverse event comprises initiating an estimation process for estimating a likelihood of the adverse event. In the embodiment of FIG. 2, weighting of the risk features in step 220 and summation of the weighted risk features in step 230 may be interpreted as an aggregation step. Sun and aggregation step may be performed by an aggregation module corresponding to weighting module 126 in the embodiment of FIG. 1, to group and prepare the extracted risk features for risk analysis. Risk analysis may occur in step 240, comprising estimating the likelihood of adverse events. Step 240 may be performed by risk analysis engine 122 of risk profile unit 120, under the control of processor 112, for example.

In one embodiment, estimating the likelihood of an adverse event may comprise performing a logistic regression on the sum of the weighted risk features formed in step 230 of the example method of FIG. 2. For instance, that sum of weighted risk features, which may be designated by the variable “z” may be used as the argument or “logit” of the logistic function. Thus, in one embodiment of the present method, step 230 may correspond to forming the sum:

$$z = {\sum }_{i = 1}^{n} {w}_{i} * {p}_{i} \qquad ( equation 1 )$$

where the pᵢ are the risk features detected in step 210, and the wᵢ are the corresponding weighting factors assigned in step 220. Then, step 240 may comprise performing a logistic regression according to:

$$f ( z ) = \frac{1}{1 + {e}^{- z}} \qquad ( equation 2 )$$

where the logit z is defined by equation 1, and equation 2 defines the logistic function ƒ(z).

Referring again to FIG. 1, in embodiments in which risk profile unit 120 includes adverse event categories database 128, risk analysis engine 122 may prioritize the estimation of the likelihood of an adverse event according to a hierarchy of importance of the various adverse event categories to which extracted risk features may correspond. For example, where risk features corresponding to fire and risk features corresponding to vulgar or profane language are extracted from the communications between users 138a and 138b, the higher importance associated with the category fire may result in the estimation of the likelihood of fire to precede the estimation of the likelihood of offensiveness produced by use of vulgar or profane language by one or both of users 138a and 138b. The hierarchy of importance of the adverse event categories stored in adverse event categories database 128 may be predetermined, for example, and may be included as data in risk profile unit 120.

Moving now to step 250 of flowchart 200, step 250 comprises alerting an administrator if the likelihood of any adverse event reaches a predetermined threshold. Step 250 may be performed by risk profile unit 120 under the control of processor 112, for example. In one embodiment, the administrator may comprise an expert system authorized to control or mobilize various resources of the real or virtual venue to intervene in order to stop or prevent the adverse event. In other embodiments, the administrator may comprise a human operator of risk profiling system 100, who may be alerted by risk profile unit 120 through a visible or audible message or alert, for example.

In some embodiments, however, step 250 may not occur. For example, in those embodiments, steps corresponding to steps 210 through 240 may be performed for many possible adverse events, with the estimated likelihood of each adverse event being recorded and compared to the likelihood of other adverse events, to provide a comprehensive risk assessment model for substantially all adverse events of interest to the operators of the real or virtual venue. In some embodiments, such a comprehensive risk assessment model could be updated substantially continuously, or periodically, according to the preferences of the venue operator and/or system constraints, to provide an ongoing assessment risk in the venue.

Thus, the present application discloses a risk profiling system and method. By extracting one or more of a plurality of possible risk features, the risk profiling system is able to identify possible sources of adverse events. By aggregating the extracted risk features, and then estimating a likelihood of each potential adverse event, the risk profiling system enables effective intervention in and/or monitoring of undesirable adverse events. Because the risk profiling provided by embodiments of the present invention can distinguish among adverse events according to both their likelihood of occurrence and their severity or importance, resources required for intervention in or suppression of adverse events can be efficiently and proportionally allocated, with reduced likelihood of overuse or misdirection of those resources.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A risk profiling system for evaluating a likelihood of an adverse event, the risk profiling system comprising:
a system processor;
a system memory storing a risk profile unit configured to be controlled by the system processor, the risk profile unit including:
a risk features database comprising a plurality of risk features corresponding to the adverse event;
an aggregation module configured to group risk features extracted by the risk profiling system; and
a risk analysis engine configured to estimate the likelihood of the adverse event from the grouped risk features.

2. The risk profiling system of claim 1, wherein the adverse event comprises an undesirable human interaction.

3. The risk profiling system of claim 1, implemented to evaluate the likelihood of adverse events comprising undesirable human interactions within a venue selected from one of a theme park and a destination resort.

4. The risk profiling system of claim 1, implemented to evaluate the likelihood of adverse events comprising undesirable interactions among visitors to a virtual venue.

5. The risk profiling system of claim 1, wherein the risk features comprise linguistic expressions.

6. The risk profiling system of claim 1, wherein the aggregation module comprises a weighting module configured to assign weighting factors to each risk feature extracted by the risk profiling system.

7. The risk profiling system of claim 6, wherein the aggregation module is further configured to sum the weighted risk features.

8. The risk profiling system of claim 6, wherein the estimation of the likelihood of the adverse event from the weighted risk features includes performing a logistic regression on a sum of the weighted risk features.

9. The risk profiling system of claim 1:
wherein the risk profile unit further comprises an adverse event categories database; and
wherein the aggregation module is configured to group the risk features extracted by the risk profiling system according to an adverse event category corresponding to each extracted risk feature.

10. The risk profiling system of claim 1:
wherein the risk profile unit further comprises an adverse event categories database; and
wherein the risk analysis engine is further configured to prioritize the estimation of the likelihood of the adverse event according to the adverse event category corresponding to each extracted risk feature.

11. A method for use by a processor of a risk profiling system for evaluating a likelihood of an adverse event, the method comprising:
extracting at least one risk feature corresponding to the adverse event;
aggregating the at least one risk feature to produce an at least one grouped risk feature; and
estimating the likelihood of the adverse event from the at least one grouped risk feature corresponding to the adverse event.

12. The method of claim 11, wherein the adverse event comprises an undesirable human interaction.

13. The method of claim 11, implemented by the risk profiling system to evaluate the likelihood of adverse events comprising undesirable human interactions within a venue selected from one of a theme park and a destination resort.

14. The method of claim 11, implemented by the risk profiling system to evaluate the likelihood adverse events comprising undesirable interactions among visitors to a virtual venue.

15. The method of claim 11, wherein extracting the at least one risk feature comprises extracting at least one linguistic expression from a communication.

16. The method of claim 11, wherein aggregating the at least one risk feature comprises assigning a weighting factor to the at least one risk feature to produce an at least one weighted risk feature.

17. The method of claim 16, wherein aggregating the at least one weighted risk feature comprises summing the at least one weighted risk feature.

18. The method of claim 16, wherein estimating the likelihood of the adverse event from the at least one weighted risk feature comprises performing a logistic regression on a sum of the at least one weighted risk feature.

19. The method of claim 11, further comprising identifying an adverse event category corresponding to the at least one risk feature, wherein aggregating the at least one risk feature extracted by the risk profiling system is performed according to the adverse events category.

20. The method of claim 11, further comprising:
identifying an adverse event category corresponding to the at least one risk feature; and
prioritizing the estimation of the likelihood of the adverse event according to the adverse event category corresponding to the at least one risk feature.
